(19) United States
(12) Patent Application Publication
(10) Pub. No.: US 2022/0413790 A1
(43) Pub. Date: Dec. 29, 2022

(54) Method and device for controlling screen display

(71) Applicant: XI'AN NOVASTAR TECH CO., LTD., XI'AN, Shaanxi (CN)

(72) Inventors: Liu CAI, XI'AN, Shaanxi (CN); Dan HAN, XI'AN, Shaanxi (CN)

(21) Appl. No.: 17/428,625

(22) PCT Filed: Mar. 20, 2020
(86) PCT No.: PCT/CN2020/080471

§ 371 Date: Aug. 4, 2021

(51) Int. Cl. G06F 3/14; G09G 3/20

(52) U.S. Cl. CPC G06F 3/1454; G09G 3/2096; G09G 2340/0492; G09G 2340/045; G09G 2370/06

(57) ABSTRACT

The present disclosure discloses a method and device for controlling screen display. The method includes that: a rotation instruction is received; a system window of a screen is rotated according to the rotation instruction, wherein when the system window is rotated, the absolute position of a play window in the system window changes accordingly; the play window is translated to a preset position in the system window; and a display image in the translated play window is transmitted to the screen for display, wherein the screen displays the display image received by a receiving card.

### TECHNICAL FIELD

The present disclosure relates to the field of display, and in particular to a method and device for controlling screen display.

### BACKGROUND

After an LED screen is delivered from the factory, it is usually necessary to install and configure the screen according to configuring instructions of the LED screen, so as to ensure the normal use of the LED screen. However, if the user installs the screen incorrectly, or needs to use the screen that has been configured as landscape to display a portrait image, or needs to use the screen that has been configured as portrait to display a landscape image, then it is necessary to modify the hardware connection and use professional software to modify parameters of screen configuring software, which is not only complicated to operate, but also requires professional personnel to provide technical support.

For the problem in the related art that when the direction of an LED screen which has been configured and the direction of the display do not match, it is necessary to reconfigure the screen, no effective solution has been proposed at present.

### SUMMARY

According to an aspect of the embodiments of the present disclosure, a method for controlling screen display is provided, which may include that: a rotation instruction is received; a system window of a screen is rotated according to the rotation instruction, wherein when the system window is rotated, the absolute position of a play window within the system window changes accordingly; the play window is translated to a preset position in the system window; and a display image in the translated play window is transmitted to the screen for display.

Furthermore, the preset position is used for representing the position where the display image in the play window is intercepted from the system window.

Furthermore, the rotation instruction comprises a rotation angle and/or a rotation direction. That the system window of the screen is rotated according to the rotation instruction may include at least one of the following: the system window is controlled to rotate according to the rotation angle indicated by the rotation instruction; and the system window is controlled to rotate according to the rotation direction indicated by the rotation instruction.

Furthermore, before the play window is translated to the preset position in the system window, it is determined, according to the rotation angle, whether size information of the play window needs to be adjusted, wherein the play window rotates along with the rotation of the system window; and if the size information of the play window needs to be adjusted, a size information of the play window is adjusted, wherein the display image in the play window is redrawn after the size information of the play window is adjusted.

Furthermore, if the size information of the play window has no need to be adjusted, the display image in the rotated play window is redrawn.

Furthermore, the rotation angle comprises one of 90°, 180° and 270°. That it is determined, according to the rotation angle, whether the size information of the play window needs to be adjusted may include that: if the rotation angle is 180°, it is determined not to adjust the size information of the play window; and if the rotation angle is 90° or 270°, it is determined to adjust the size information of the play window.

Furthermore, the size information comprises a first length of the play window in a first direction of a play plane, and a second length of the play window in a second direction of the play plane, wherein the first direction is vertical to the second direction. That the size information of the play window is adjusted may include that: the first length of the play window before adjustment is determined as the second length of the play window after adjustment; and the second length of the play window before adjustment is determined as the first length of the play window after adjustment.

Furthermore, that a display image in the translated play window is transmitted to the screen for display may include that: the display image in the translated play window is transmitted to a processing module. The processing module intercepts the display image according to a layout parameter of the play window, and sends intercepted image information to the screen for display.

Furthermore, before a display image in the translated play window is transmitted to the screen for display, the display image in the play window is redrawn after the size information of the play window is adjusted, which may specifically include that: a relative position of each child image layer on a parent image layer in an unrotated play window is obtained, wherein the parent image layer is the next image layer adjacent to the child image layer; and taking the play window whose size information has been adjusted as a root image layer at the bottom level, each image layer is drawn in order from lowest to highest according to the relative position of each child image layer on the parent image layer until all image layers are drawn.

According to another aspect of the embodiments of the present disclosure, a method for controlling screen display is also provided, which may include that: a play window is displayed in a first mode in a display area of a screen; and in response to a rotation instruction, the play window is displayed in a second mode in the display area of the screen. The rotation instruction comprises a preset rotation angle, and the play window in the second mode is rotated the preset rotation angle relative to the play window in the first mode.

Furthermore, when the rotation angle is 90° or 270°, length and width information of a first display image is opposite to that of a second display image; when the rotation angle is 180°, the first display image is opposite to the second display image in the vertical direction, wherein the first display image is the display image in the play window displayed in the first mode, and the second display image is the display image in the play window displayed in the second mode.

According to another aspect of the embodiments of the present disclosure, a system for controlling screen display is also provided, which may include: a sending card, a receiving card and a screen. The sending card is configured to receive a rotation instruction, rotate a system window of a screen according to the rotation instruction, translate a play window to a preset position in the system window, and transmit a display image in the translated play window to a receiving card. When the system window is rotated, the absolute position of the play window in the system window changes accordingly. The receiving card is configured to receive the display image sent by the sending card, and transmit the display image to the screen. The screen is configured to display the display image transmitted by the receiving card.

Furthermore, the system may include: a logic controller, which is connected between the sending card and the receiving card, and configured to intercept the play window according to a preset size, and send the intercepted display image to the receiving card.

According to another aspect of the embodiments of the present disclosure, a device for controlling screen display is also provided, which may include a receiving module, a rotating module, a translating module and a transmitting module. The receiving module is configured to receive a rotation instruction. The rotating module is configured to rotate a system window of a screen according to the rotation instruction. When the system window is rotated, the absolute position of a play window in the system window changes accordingly. The translating module is configured to translate the play window to a preset position in the system window. The transmitting module is configured to transmit a display image in the translated play window to the screen for display.

According to another aspect of the embodiments of the present disclosure, a storage medium is also provided, which may include a stored program. When running, the program controls a device where the storage medium is to execute the method for controlling screen display.

According to another aspect of the embodiments of the present disclosure, a processor is also provided, which is configured to run a program. When running, the program executes the method for controlling screen display.

### BRIEF DESCRIPTION OF THE DRAWINGS

The accompanying drawings described here are used for providing further understanding of the present disclosure, and constitute a part of the present disclosure. Schematic embodiments of The present disclosure and description thereof are used for illustrating the present disclosure and not intended to form an improper limit to the present disclosure. In the accompanying drawings:

FIG. 1 is a flowchart of a method for controlling screen display according to an embodiment of the present disclosure;

FIG. 2a is a schematic diagram of displaying a play window in a system window;

FIG. 2b is a schematic diagram of rotating a system window 90° according to an embodiment of the present disclosure;

FIG. 2c is a schematic diagram of rotating a system window 180° according to an embodiment of the present disclosure;

FIG. 2d is a schematic diagram of rotating a system window 270° according to an embodiment of the present disclosure;

FIG. 3 is a schematic diagram of using a landscape screen to display a portrait image;

FIG. 4 is a schematic diagram of rotating by one click according to an embodiment of the present disclosure;

FIG. 5 is a schematic diagram of a method for controlling screen display according to an embodiment of the present disclosure;

FIG. 6 is a flowchart of another method for controlling screen display according to an embodiment of the present disclosure;

FIG. 7 is a schematic diagram of a system for controlling screen display according to an embodiment of the present disclosure;

FIG. 8 is a schematic diagram of a device for controlling screen display according to an embodiment of the present disclosure; and

FIG. 9 is a schematic diagram of another device for controlling screen display according to an embodiment of the present disclosure.

### DETAILED DESCRIPTION OF THE EMBODIMENTS

In order to make those skilled in the art understand the solutions of the present disclosure better, the technical solutions in the embodiments of the present disclosure are clearly and completely elaborated below in combination with the accompanying drawings. It is apparent that the described embodiments are only a part of the embodiments of the present disclosure but not all. On the basis of the embodiment of the present disclosure, all other embodiments obtained on the premise of no creative work of those skilled in the art should fall within the protection scope of the present disclosure.

It should be noted that the specification and claims of the present disclosure and terms “first”, “second”, etc. in the foregoing drawings are used for distinguishing similar objects rather than describing a specific sequence or a precedence order. It should be understood that the objects may be exchanged under appropriate circumstances, so that the embodiments of the present disclosure described here may be implemented in an order different from that described or shown here. In addition, terms “include” and “have” and any variations thereof are intended to cover non-exclusive inclusions. For example, it is not limited for processes, methods, systems, products or devices containing a series of steps or units to clearly list those steps or units, and other steps or units which are not clearly listed or are inherent to these processes, methods, products or devices may be included instead.

### Embodiment 1

According to the embodiments of the present disclosure, an embodiment of a method for controlling screen display is provided. It is to be noted that these steps presented in the flowchart of the accompanying drawings can be executed in a computer system like a group of computer executable instructions, and moreover, although a logical sequence is shown in the flowchart, in some cases, the presented or described steps can be performed in a sequence different from that described here.

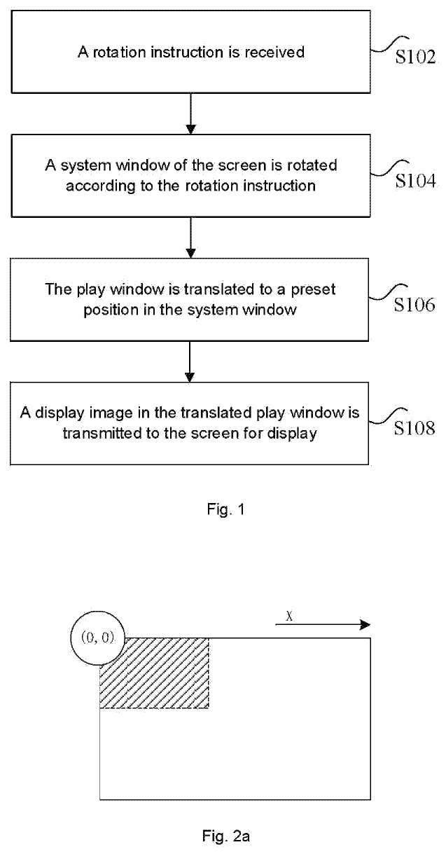

FIG. 1 is a flowchart of a method for controlling screen display according to an embodiment of the present disclosure. As shown in FIG. 1, the method may include the following steps.

At S102, a rotation instruction is received.

Specifically, the rotation instruction may be given by the user operating on a human-computer interaction interface displayed on a screen, may also be given by the user operating on a remote control used for controlling the screen, and may also be given by the user on other control devices communicating with the screen, for example, a mobile terminal communicating with the screen.

In an optional embodiment, the user may call up a control interface displayed on the screen by operating the screen. The control interface includes a variety of control controls for the screen, which include at least a rotation control. The user may give the rotation instruction to the screen by selecting the rotation control in the control interface. At this point, the screen receives the rotation instruction through its touch component.

In another optional embodiment, the remote control for the user to control the screen has the rotation control, and the user may select the rotation control by operating the remote control, so as to give the rotation instruction to the screen. At this point, the screen receives the rotation instruction through an infrared signal.

In yet another optional embodiment, the screen may communicate with a mobile terminal, and may control the screen through the mobile terminal. In this example, the user may operate on the mobile terminal to send the rotation instruction to the screen. At this point, the screen receives the rotation instruction through Bluetooth, wireless and other modes.

When the user of the screen needs to play multimedia content in a portrait mode, but the screen has been fixedly configured as a landscape screen size in the factory, in order to avoid the tedious operation of reconfiguring the screen, the user may give the rotation instruction to the screen to achieve the effect of portrait play on the screen configured as landscape. Similarly, when the user of the screen needs to play the multimedia content in a landscape mode, but the screen has been fixedly configured as a portrait screen size in the factory, in order to avoid the tedious operation of reconfiguring the screen, the user may also give the rotation instruction to the screen to achieve the effect of landscape play on the screen configured as portrait.

At S104, a system window of the screen is rotated according to the rotation instruction. When the system window is rotated, the absolute position of a play window within the system window changes accordingly.

Specifically, the system window is used for representing a display window corresponding to the screen's own operating system. The play window is always displayed in the upper-left corner of the system window without translation. The play window may be created by a sending card. The sending card may be set in a multimedia box. During the display of the screen, the sending card creates a play window according to the size of the configured screen and transmits each frame of video memory to a Field Programmable Gate Array (FPGA) module, and after the FPGA module intercepts the image of the play window according to the preset size of the configured screen, interface data is transmitted to the screen for display, and the screen displays according to the image received by a receiving card. It is to be noted that the position where the FPGA intercepts the play window does not change with the rotation of the system window.

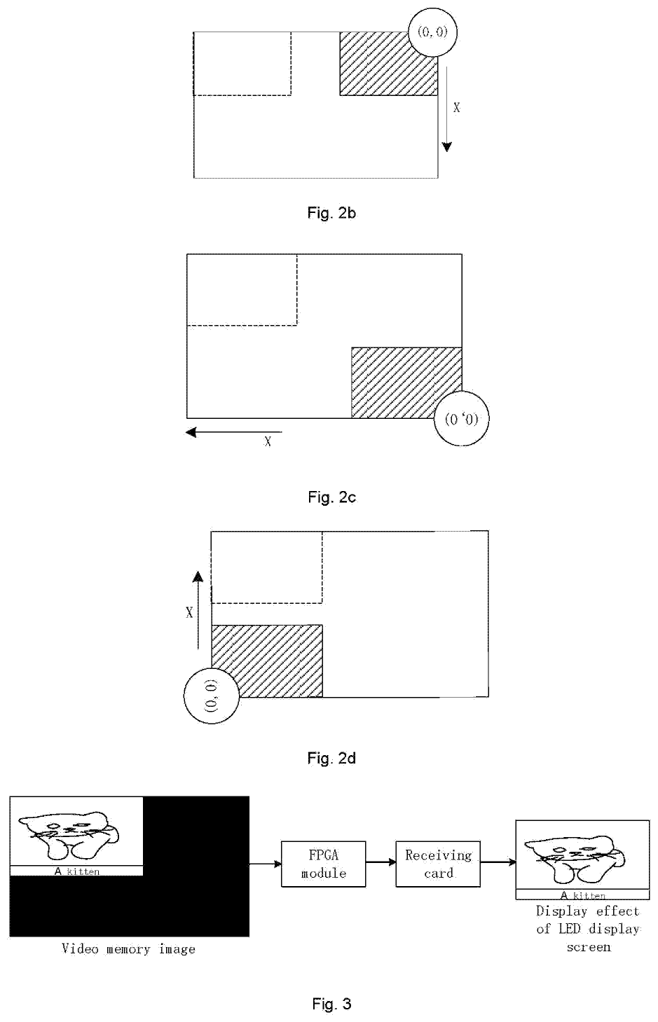

FIG. 2a is a schematic diagram of displaying the play window in the system window. As shown in FIG. 2a, taking that the coordinate of the upper left corner of the play window is (0, 0) and landscape orientation is the X-axis as an example, the coordinate of the upper left corner of the play window is at (0, 0), and the system window does not rotate at this time. FIG. 2b is a schematic diagram of rotating the system window 90° according to an embodiment of the present disclosure. As shown in FIG. 2b, after rotated 90°, the system window is stretched laterally to fit the display device, the portion filled with the left slashes is used to represent the play window, and the dashed rectangle is used to represent the area intercepted by the FPGA. The relative position of the play window and the system window is fixed, but the position of the play window has changed relative to the world coordinate system. FIG. 2c is a schematic diagram of rotating the system window 180° according to an embodiment of the present disclosure. FIG. 2d is a schematic diagram of rotating a system window 270° according to an embodiment of the present disclosure. Similar to FIG. 2b, after rotated 270°, the system window is stretched laterally to fit the display device, and because the relative position of the play window and the system window is fixed, the position of the play window has changed relative to the world coordinate system.

It is to be noted that the position where the FPGA intercepts the play window does not change with the rotation of the system window, that is, as shown in FIG. 2b, FIG. 2c and FIG. 2d, the position where the FPGA intercepts the play window is always the upper left corner of the world coordinate system, so after the system window is rotated, the FPGA may not be able to intercept the play window. Therefore, S106 is also required.

At S106, the play window is translated to a preset position in the system window.

Specifically, the preset position is used for representing the position that the FPGA module intercepts.

In an optional embodiment, the FPGA intercepts the upper left corner in the world coordinate system according to the preset size of the configured screen, so the preset position is the upper left corner of the world coordinate system.

At S108, a display image in the translated play window is transmitted to the screen for display.

In the above solution, the translated play window has been able to be intercepted by the FPGA module, so the display image in the translated play window may be directly transmitted to the screen for display.

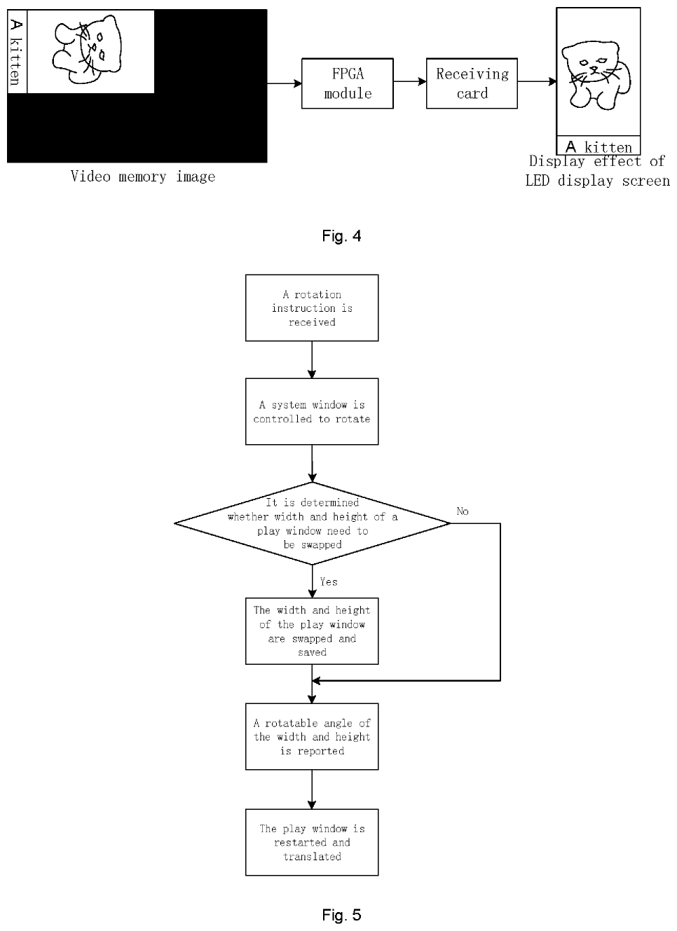

In an optional embodiment, when the user of the screen needs to play the multimedia content in the portrait mode, but the screen has been configured as a landscape screen size in the factory, if the screen is used directly, a display effect shown in FIG. 3 appears. Based on the above solution in the embodiment, the user may send a rotation instruction of rotating 90° to the screen, so that the played image may be displayed on the screen in the portrait mode. FIG. 4 is a schematic diagram of rotating by one click according to an embodiment of the present disclosure. As shown in FIG. 4, the screen has been configured as a landscape screen, so it can only display image in the landscape mode. But the user's requirement is to display image in the portrait mode, so the rotation instruction is sent to the screen. The sending card matching the screen may perform the above step to complete the rotation of the image. The sending card transmits the display image in the adjusted play window to the FPGA module, the FPGA module intercepts the image in the play window and sends it to the receiving card, and then the receiving card transmits the display image to the screen to display the image on the screen in the portrait mode.

It is to be noted that if the rotation is performed through the FPGA module, it only rotates the image, and stretches the image of the landscape screen size to fill the portrait screen size, or compacts the image of the portrait screen size to fill the window with the landscape screen size. This method is only applicable to a still image without special effects, does not have a good display effect for dynamic text and other multimedia content, and cannot achieve an automatic layout effect from the landscape screen to the portrait screen. In the above solution of the embodiment, the system window is rotated by the sending card, and then the play window is translated, thus it not only has a good rotation effect on different static images, but also has a good performance on non-hierarchical windows like SurfaceView, which are usually applied to scrolling subtitles.

It can be seen from the above that in the embodiments of the present disclosure, the rotation instruction is received; the system window of the screen is rotated according to the rotation instruction, wherein when the system window is rotated, the absolute position of the play window within the system window changes accordingly; the play window is translated to the preset position in the system window; and the display image in the translated play window is transmitted to the screen for display. In the above solution, the system window is rotated, and then the play window in the system window is translated, so that the configured LED screen can be directly applied just by rotating and automatically lay out the play window without rewiring hardware and modifying the parameters of the screen configuring software, and the effect of random switch between landscape and portrait can be achieved, thus solving the problem in the related art that when the direction of an LED screen which has been configured and the direction of the display do not match, it is necessary to reconfigure the screen.

As an optional embodiment, the preset position is used for representing the position where the display image in the play window is intercepted from the system window.

In the above solution, the play window is translated to the position where the play window is intercepted from the system window, so that the FPGA module can still intercept the display image in the play window after the system window is rotated.

As an optional embodiment, the rotation instruction comprises a rotation angle and/or a rotation direction. That the system window of the screen is rotated according to the rotation instruction may include at least one of the following: the system window is controlled to rotate according to the rotation angle indicated by the rotation instruction; and the system window is controlled to rotate according to the rotation direction indicated by the rotation instruction.

Specifically, the rotation angle may be the rotation angle relative to the original system window. The rotation angle here may be multiples of 90°, such as 90°, 180°, and 270°.

In an optional embodiment, 90°, 180°, and 270° each correspond to a state. When the user selects the rotation of 90°, the system window presents the state corresponding to 90°, and then when the user selects the rotation of 180° , the system window is not rotated 180° on the basis of 90°, but is rotated again to the state corresponding to 180° on the basis of the original state. “90°”, “180°” and “270° ” may be displayed on the human-computer interaction interface provided for the user, and the user may select according to needs.

In another optional embodiment, on the human-computer interaction interface provided for the user, the explicit rotation angle is not indicated, but the rotation effect according to each rotation angle is displayed, so that the user may make visual selection.

In the above solution, by setting the rotation angle in the rotation instruction, the system window may be rotated according to the specified rotation angle, so as to meet the user's demands for screen rotation at one time.

In an optional embodiment, the rotating direction is a specified direction; for example, if it is specified as clockwise rotation, then each rotation instruction is rotating clockwise based on the original system window.

In another optional embodiment, the above rotation direction may be specified by the user. If the same rotation angle matches different rotation directions, there will be different rotation effects. Therefore, the user may control the system window to rotate in different directions according to the actual display demands.

As an optional embodiment, before the play window is translated to the preset position in the system window, the method may further include that: it is determined, according to the rotation angle, whether size information of the play window needs to be adjusted, wherein the play window rotates along with the rotation of the system window; and if the size information of the play window needs to be adjusted, a size information of the play window is adjusted, wherein the display image in the play window is redrawn after the size information of the play window is adjusted.

When the system window rotates, the play window in the system window also rotates. When the rotation angle is 90° or 270°, the length and width of the rotated play image is swapped, and because the size and position of the intercepted display image are fixed when the FPGA intercepts the display image and sends it to the screen for display, in order to enable the FPGA to completely intercept the display image in the play window, before the play window is translated to the preset position in the system window, it is also needed to adjust size information of the play window to make its size information match the size information intercepted by the FPGA, thus achieving the effect of rotating the display image in the play window.

It is to be noted that after the size information of the play window is adjusted, because the play window has been rotated, the display image in the play window will also be rotated by redrawing. In an optional embodiment, the image in the play window usually includes multiple image layers. During redrawing, the image layers are drawn in order from lowest to highest, that is, the lowest image layer is drawn first, and then the upper image layer is drawn in turn until each image layer in the play window is drawn. Before the display image is redrawn, it is needed to record the position of each child image layer in the image on its parent image layer. The child image layer is on the parent image layer. After the parent image layer is drawn, the position of its child image layer on the parent image layer is recalculated to draw the child image layer, and this calculation is repeated in turn until all the image layers are redrawn.

It is also to be noted that in the embodiment, there is no limit on the order of rotating the play window and adjusting the size information of the play window, that is, the play window may be rotated first before adjusting the size information of the play window, or the size information of the play window may be adjusted first before rotating the play window. The step of redrawing the display image is after the play window is rotated and the size information of the play window is adjusted.

As an optional embodiment, if the size information of the play window has no need to be adjusted, the display image in the rotated play window is redrawn.

In the above solution, if it is determined that there is no need to adjust the size information of the play window, then the display image in the rotated play window may be directly redrawn, and the steps of translating the play window to the preset position in the system window is executed.

The way of redrawing the display image in the rotated play window is the same as the way of redrawing the display image in the play window whose size information is adjusted, so it will not be repeated here.

In an optional embodiment, in the case of a rectangular screen, the size information of the play window includes two parts, namely length and width. If the rotation angle indicated in the rotation instruction is 180°, the length and width of the play window do not need to change, and if the rotation angle indicated in the rotation instruction is 90° or 270°, the length and width of the play window are difficult to match the area intercepted by the FPGA, so they need to be adjusted.

As an optional embodiment, the rotation angle comprises one of 90°, 180° and 270°. That it is determined, according to the rotation angle, whether the size information of the play window needs to be adjusted may include that: if the rotation angle is 180°, it is determined not to adjust the size information of the play window; and if the rotation angle is 90° or 270°, it is determined to adjust the size information of the play window.

In the above solution, if the rotation angle is 90° or 270°, the image originally displayed in the portrait mode is rotated to landscape, or the image originally displayed in the landscape mode is rotated to portrait. It is apparent that when the size of the configured screen is not a square, such rotation will swap length information and width information of the image, so it is needed to adjust the size information of the play window to match the size of the configured screen.

If the rotation angle is 180°, the image originally displayed in the portrait mode is still displayed in the portrait mode, and the image originally displayed in the landscape mode is still displayed in the landscape mode after rotation. It is apparent that in this case, the size information of the play window matches the size of the configured screen, so there is no need to adjust the size information of the play window.

As an optional embodiment, the size information comprises a first length of the play window in a first direction of a play plane, and a second length of the play window in a second direction of the play plane. The first direction is vertical to the second direction. That the size information of the play window is adjusted may include that: the first length of the play window before adjustment is determined as the second length of the play window after adjustment; and the second length of the play window before adjustment is determined as the first length of the play window after adjustment.

Specifically, the first direction and the second direction of the play plane may be vertical and horizontal respectively, and the first length of the first direction and the second length of the second direction are respectively length and width. The above solution is used for swapping the length and the width of the play window to form a new play window.

In an optional embodiment, the image in the play window is rotated 90°. In order to match the size of the configured screen, the original width of the play window is adjusted to the current length, and the original length is adjusted to the current width, so that the adjustment of the play window is realized, and the adjusted play window corresponds to the size of the configured screen.

As an optional embodiment, that the display image in the translated play window is transmitted to the screen for display may include that: the display image in the translated play window is transmitted to a processing module. The processing module intercepts the display image according to a layout parameter of the play window, and sends intercepted image information to the screen for display.

Specifically, the logic processing module may be the FPGA module, which is configured to intercept the play window.

In the above solution, the sending card sends the display image in the play window to the logic processing module, the logic processing module intercepts the play window according to the size of the configured screen and sends the intercepted image to the receiving card, and the screen displays according to the image received by the receiving card, thus completing the rotation of the image.

FIG. 5 is a schematic diagram of a method for controlling screen display according to an embodiment of the present disclosure. The method for controlling screen display is illustrated below in combination with FIG. 4. First, the rotation instruction issued by the user through an upper computer is received, and the system window of the screen is controlled to rotate. Then, it is determined whether the width and the height of the play window need to be swapped. If the rotation angle is 180°, it is determined that the width and the height of the play window do not need to be swapped. If the rotation angle is 90° or 270°, it is determined that the width and the height of the play window need to be swapped, and after the width and the height of the play window are swapped, the new width and height are stored to DislayRect of ScreenInfoManager, and then the width and the height of the play window as well as the rotation angle are reported.

After the screen is restarted, the left edge position (left) and the top edge position (top) of the play window rectangle are recalculated, so that the play window can be translated to the specified position where the FPGA intercepts it.

As an optional embodiment, before the display image in the translated play window is transmitted to the screen for display, the method may further include that: the display image in the play window is redrawn after the size information of the play window is adjusted, which may specifically include that: the relative position of each child image layer on the parent image layer in an unrotated play window is obtained, wherein the parent image layer is the next image layer adjacent to the child image layer; and taking the play window whose size information has been adjusted as a root image layer at the bottom level, each image layer is drawn in order from lowest to highest according to the relative position of each child image layer on the parent image layer until all image layers are drawn.

The play window is rotated along with the rotation of the system window before translated, so before the play window is translated, it is also needed to redraw the display image in the play window according to the rotation of the play window.

In the above solution, the play window includes multiple image layers, and the play window is the root image layer of these image layers. The rotation of the play window is the rotation of the root image layer. After the play window is rotated, the display image is redrawn. During redrawing, the image layers are drawn in order from lowest to highest, that is, the lowest image layer is drawn first, and then the upper image layer is drawn in turn until each image layer in the play window is drawn.

Specifically, before drawing, it is needed to record the relative position of each child image layer in the image on its parent image layer. After the parent image layer is drawn, the position of its child image layer on the parent image layer after drawing is recalculated according to the position, recorded in advance, of the child image layer on the parent image layer to draw the child image layer, and this calculation is repeated in turn until all the image layers are drawn.

### Embodiment 2

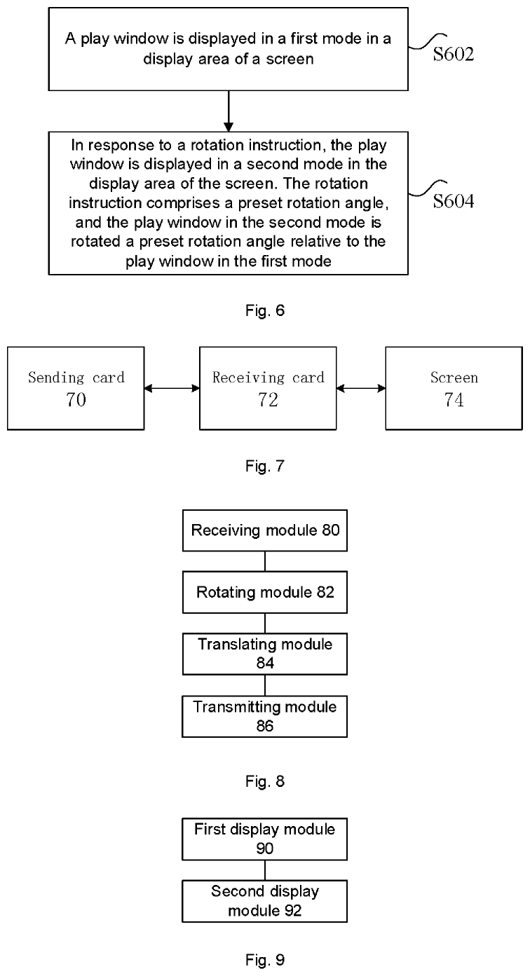

According to the present disclosure, an embodiment of another method for controlling screen display is provided. FIG. 6 is a flowchart of another method for controlling screen display according to an embodiment of the present disclosure. As shown in FIG. 6, the method may include the following steps.

At S602, a play window is displayed in a first mode in a display area of a screen.

Specifically, the first mode may be a landscape display mode or a portrait display mode.

At S604, in response to a rotation instruction, the play window is displayed in a second mode in the display area of the screen. The rotation instruction comprises a preset rotation angle, and the play window in the second mode is rotated a preset rotation angle relative to the play window in the first mode.

Specifically, the second mode is a display mode different from the first mode, and it may be a display mode after the play content is rotated based on the first mode.

In an optional embodiment, the rotation angle of the first mode is 0°, that is, the first mode is the original display mode without rotation. On this basis, the user gives a rotation instruction of rotating 90° to the screen, and the screen rotates according to the rotation instruction, then the play window may be displayed in the second mode in the display area of the screen. The rotation of the play window may be realized by any method for controlling screen display in embodiment 1, which will not be repeated here.

As an optional embodiment, when the rotation angle is 90° or 270°, length and width information of a first display image is opposite to that of a second display image. When the rotation angle is 180°, the first display image is opposite to the second display image in the vertical direction. The first display image is the display image in the play window displayed in the first mode, and the second display image is the display image in the play window displayed in the second mode.

### Embodiment 3

According to the present disclosure, an embodiment of a system for controlling screen display is provided. FIG. 7 is a schematic diagram of the system for controlling screen display according to an embodiment of the present disclosure. As shown in FIG. 7, the system may include: a sending card 70, a receiving card 72 and a screen 74.

The sending card 70 is configured to receive the rotation instruction, rotate the system window of the screen according to the rotation instruction, translate the play window to the preset position in the system window, and transmit the display image in the translated play window to the receiving card. When the system window is rotated, the absolute position of the play window in the system window changes accordingly.

The receiving card 72 is configured to receive the display image sent by the sending card, and transmit the display image to the screen.

The screen 74 is configured to display the display image transmitted by the receiving card.

Specifically, the rotation instruction may be given by the user operating on the human-computer interaction interface displayed on the screen, may also be given by the user operating on the remote control used for controlling the screen, and may also be given by the user on other control devices communicating with the screen, for example, the mobile terminal communicating with the screen.

In an optional embodiment, the user may call up the control interface displayed on the screen by operating the screen. The control interface includes a variety of control controls for the screen, which include at least the rotation control. The user may give the rotation instruction to the screen by selecting the rotation control in the control interface. At this point, the screen receives the rotation instruction through its touch component.

In another optional embodiment, the remote control for the user to control the screen has the rotation control, and the user may select the rotation control by operating the remote control, so as to give the rotation instruction to the screen. At this point, the screen receives the rotation instruction through an infrared signal.

In yet another optional embodiment, the screen may communicate with a mobile terminal, and may control the screen through the mobile terminal. In this example, the user may operate on the mobile terminal to send the rotation instruction to the screen. At this point, the screen receives the rotation instruction through Bluetooth, wireless and other modes.

When the user of the screen needs to play the multimedia content in a portrait mode, but the screen has been fixedly configured as the landscape screen size in the factory, in order to avoid the tedious operation of reconfiguring the screen, the user may give the rotation instruction to the screen to achieve the effect of portrait play on the screen configured as landscape. Similarly, when the user of the screen needs to play the multimedia content in the landscape mode, but the screen has been fixedly configured as the portrait screen size in the factory, in order to avoid the tedious operation of reconfiguring the screen, the user may also give the rotation instruction to the screen to achieve the effect of landscape play on the screen configured as portrait.

The system window is used for representing the display window corresponding to the screen's own operating system. The play window is always displayed in the upper-left corner of the system window without translation. The play window may be created by the sending card. The sending card may be set in the multimedia box. During the display of the screen, the sending card creates the play window according to the size of the configured screen and transmits each frame of video memory to the FPGA module, and after the FPGA module intercepts the image of the play window according to the preset size of the configured screen, the interface data is transmitted to the screen for display, and the screen displays according to the image received by the receiving card. It is to be noted that the position where the FPGA intercepts the play window does not change with the rotation of the system window.

FIG. 2a is a schematic diagram of displaying the play window in the system window. As shown in FIG. 2a, taking that the coordinate of the upper left corner of the play window is (0, 0) and landscape orientation is the X-axis as an example, the coordinate of the upper left corner of the play window is at (0, 0), and the system window does not rotate at this time. FIG. 2b is a schematic diagram of rotating the system window 90° according to an embodiment of the present disclosure. As shown in FIG. 2b, the portion filled with the left slashes is used to represent the play window, and the dashed rectangle is used to represent the area intercepted by the FPGA. The relative position of the play window and the system window is fixed, but the position of the play window has changed relative to the world coordinate system. FIG. 2c is a schematic diagram of rotating the system window 180° according to an embodiment of the present disclosure. FIG. 2d is a schematic diagram of rotating a system window 270° according to an embodiment of the present disclosure. Similar to FIG. 2b, after the system window is rotated, because the relative position of the play window and the system window is fixed, the position of the play window has changed relative to the world coordinate system.

It is to be noted that the position where the FPGA intercepts the play window does not change with the rotation of the system window, that is, as shown in FIG. 2b, FIG. 2c and FIG. 2d, the position where the FPGA intercepts the play window is always the upper left corner of the world coordinate system, so after the system window is rotated, the FPGA may not be able to intercept the play window. Therefore, S106 is also required.

The preset position is used for representing the position that the FPGA module intercepts. In an optional embodiment, the FPGA intercepts the upper left corner in the world coordinate system according to the preset size of the configured screen, so the preset position is the upper left corner of the world coordinate system.

In the above solution, the translated play window has been able to be intercepted by the FPGA module, so the display image in the translated play window may be directly transmitted to the screen for display on the screen.

In an optional embodiment, when the user of the screen needs to play the multimedia content in the portrait mode, but the screen has been configured as the landscape screen size in the factory, if the screen is used directly, the display effect shown in FIG. 3 appears. Based on the above solution in the embodiment, the user may send the rotation instruction of rotating 90° to the screen, so that the played image may be displayed on the screen in the portrait mode. FIG. 4 is a schematic diagram according to an embodiment of the present disclosure. As shown in FIG. 4, the screen has been configured as the landscape screen, so it can only display image in the landscape mode. But the user's requirement is to display image in the portrait mode, so the rotation instruction is sent to the screen. The sending card matching the screen may perform the above step to complete the rotation of the image. The sending card transmits the display image in the adjusted play window to the FPGA module, the FPGA module intercepts the image in the play window and sends it to the receiving card, and then the receiving card transmits the display image to the screen to display the image on the screen in the portrait mode.

It is to be noted that if the rotation is performed through the FPGA module, it only rotates the image, and stretches the image of the landscape screen size to fill the portrait screen size, or compacts the image of the portrait screen size to fill the window with the landscape screen size. This method is only applicable to a still image without special effects, does not have a good display effect for dynamic text and other multimedia content, and cannot achieve an automatic layout effect from the landscape screen to the portrait screen. In the above solution of the embodiment, the system window is rotated by the sending card, and then the play window is translated, thus it not only has a good rotation effect on different static images, but also has a good performance on non-hierarchical windows like SurfaceView which are usually applied to scrolling subtitles.

It can be seen from the above that in the embodiments of the present disclosure, the rotation instruction is received through the sending card; the system window of the screen is rotated according to the rotation instruction, wherein when the system window is rotated, the absolute position of the play window in the system window changes accordingly; the play window is translated to the preset position in the system window; and the display image in the translated play window is transmitted to the screen for display. The screen displays the display image received by the receiving card. In the above solution, the system window is rotated, and then the play window in the system window is translated, so that the configured LED screen can be directly applied just by rotating and automatically lay out the play window without rewiring hardware and modifying the parameters of the screen configuring software, and the effect of random switch between landscape and portrait can be achieved, thus solving the problem in the related art that when the direction of an LED screen which has been configured and the direction of the display do not match, it is necessary to reconfigure the screen.

As an optional embodiment, the system may include: a logic controller, which is connected between the sending card and the receiving card, and configured to intercept the play window according to a preset size, and send the intercepted display image to the receiving card.

It is to be noted that the sending card in the embodiment also allows the execution of any step in embodiment 1, which will not be repeated here.

### Embodiment 4

According to the present disclosure, an embodiment of a device for controlling screen display is provided. FIG. 8 is a schematic diagram of the device for controlling screen display according to an embodiment of the present disclosure. As shown in FIG. 8, the device may include: a receiving module 80, a rotating module 82, a translating module 84 and a transmitting module 86.

The receiving module 80 is configured to receive the rotation instruction.

The rotating module 82 is configured to rotate the system window of the screen according to the rotation instruction. When the system window is rotated, the absolute position of the play window within the system window changes accordingly.

The translating module 84 is configured to translate the play window to the preset position in the system window.

The transmitting module 86 is configured to transmit the display image in the translated play window to the screen for display.

As an optional embodiment, the preset position is used for representing the position where the display image in the play window is intercepted from the system window.

As an optional embodiment, the rotation instruction includes the rotation angle and/or the rotating direction. The rotating module includes at least one of the following: a first control submodule, which is configured to control the system window to rotate according to the rotation angle indicated by the rotation instruction; and a second control submodule, which is configured to control the system window to rotate according to the rotation direction indicated by the rotation instruction.

As an optional embodiment, the device may further include: a determining module and an adjusting module. The determining module is configured to determine according to the rotation angle, before the play window is translated to the preset position in the system window, whether the size information of the play window needs to be adjusted. The play window rotates along with the rotation of the system window. The adjusting module is configured adjust, if the size information of the play window needs to be adjusted, the size information of the play window. The display image in the play window is redrawn after the size information of the play window is adjusted.

As an optional embodiment, if the size information of the play window has no need to be adjusted, the display image in the rotated play window is redrawn.

As an optional embodiment, the rotation angle comprises one of 90°, 180° and 270°. The determining module includes: a first determining submodule, which is configured to determine not to adjust the size information of the play window if the rotation angle is 180°; and a second determining submodule, which is configured to determine to adjust the size information of the play window if the rotation angle is 90° or 270°.

As an optional embodiment, the size information comprises the first length of the play window in the first direction of the play plane, and the second length of the play window in the second direction of the play plane. The first direction is vertical to the second direction. The adjusting module includes: a third determining submodule, which is configured to determine the first length of the play window before adjustment as the second length of the play window after adjustment; and a fourth determining submodule, which is configured to determine the second length of the play window before adjustment as the first length of the play window after adjustment.

As an optional embodiment, the transmitting module includes: a transmitting submodule, which is configured to transmit the display image in the translated play window to the processing module. The processing module intercepts the display image according to the layout parameter of the play window, and sends the intercepted image information to the screen for display.

As an optional embodiment, the device may further include: a drawing module, which is configured to redraw, before the display image in the translated play window is transmitted to the screen for display, the display image in the play window after the size information of the play window is adjusted. The drawing module specifically includes: an obtaining submodule, which is configured to obtain the relative position of each child image layer on the parent image layer in the unrotated play window, wherein the parent image layer is the next image layer adjacent to the child image layer; and a drawing submodule, which is configured to draw, taking the play window whose size information has been adjusted as the root image layer at the bottom level, each image layer in order from lowest to highest according to the relative position of each child image layer on the parent image layer until all image layers are drawn.

### Embodiment 5

According to the present disclosure, an embodiment of another device for controlling screen display is provided. FIG. 9 is a schematic diagram of another device for controlling screen display according to an embodiment of the present disclosure. As shown in FIG. 9, the device may include: a first display module 90 and a second display module 92.

The first display module 90 is configured to display the play window in the first mode in the display area of the screen.

The second display module is configured to display, in response to the rotation instruction, the play window in the second mode in the display area of the screen. The rotation instruction comprises the preset rotation angle, and the play window in the second mode is rotated the preset rotation angle relative to the play window in the first mode.

As an optional embodiment, when the rotation angle is 90° or 270°, the length and width information of the first display image is opposite to that of the second display image. When the rotation angle is 180°, the first display image is opposite to the second display image in the vertical direction. The first display image is the display image in the play window displayed in the first mode, and the second display image is the display image in the play window displayed in the second mode.

### Embodiment 6

According to the embodiments of the present disclosure, a storage medium is provided, which may include a stored program. When running, the program controls a device where the storage medium is to execute the method for controlling screen display in embodiment 1.

### Embodiment 7

According to the embodiments of the present disclosure, a processor is provided, which is configured to run a program. When running, the program executes the method for controlling screen display in embodiment 1.

The sequence numbers of the embodiments of the present disclosure are just for describing, instead of representing superiority or inferiority of the embodiments.

In the above embodiments of the present disclosure, the descriptions of the embodiments focus on different aspects. A part which is not described in a certain embodiment in detail may refer to the related description of the other embodiments.

In the several embodiments provided in the present disclosure, it should be understood that the technical contents disclosed may be realized in other ways. The embodiment of the device described above is only schematic; for example, the division of the units is only a division of logical functions, and there may be other dividing modes during the actual implementation, for example, multiple units or components may be combined or integrated to another system, or some features may be ignored or are not executed. In addition, coupling, direct coupling, or communication connection shown or discussed may be implemented through indirect coupling or communication connection of some interfaces, units or modules, and may be in an electrical form or other forms.

The units described as separate parts may be or may not be separate physically. The part shown as the unit may be or may not be a physical unit, that is to say, it may be in a place or distributed on multiple network units. Part or all of the units may be selected to achieve the purpose of the solutions of the embodiments according to a practical requirement.

In addition, each functional unit in each embodiment of the present disclosure may be integrated into a processing unit, each unit may also physically exist independently, and two or more than two units may also be integrated into a unit. The integrated unit may be realized in form of hardware or in form of software function unit.

If the integrated unit is implemented by software function modules, and the software function modules are sold or used as independent products, they can also be stored in a computer readable storage medium. Based on this understanding, the technical solution of the present disclosure substantially or the part making a contribution to the conventional art can be embodied in the form of software product; the computer software product is stored in a storage medium, and includes a number of instructions to make a computer device (which may be a personal computer, a server or a network device, etc.) perform all or part of steps of the method in each embodiment of the present disclosure. The storage media include, but not limited to, a USB flash disk, an ROM, an RAM, a mobile hard disk, a magnetic disk, a compact disc, and other media capable of storing the program codes.

The above is only the preferred embodiments of the present disclosure; it should be indicated that, on the premise of not departing from the principles of the present disclosure, those of ordinary skill in the art may also make a number of improvements and supplements, and these improvements and supplements should fall within the protection scope of the present disclosure.

What is claimed is:

1. A method for controlling screen display, comprising:
receiving a rotation instruction;
rotating a system window of the screen according to the rotation instruction, wherein when the system window is rotated, the absolute position of a play window in the system window changes accordingly;
translating the play window to a preset position in the system window; and
transmitting a display image in the translated play window to the screen for display.

2. The method as claimed in claim 1, wherein the preset position is used for representing a position where the display image in the play window is intercepted from the system window.

3. The method as claimed in claim 1, wherein the rotation instruction comprises at least one of a rotation angle and a rotation direction; rotating the system window of the screen according to the rotation instruction comprises at least one of the following:
controlling the system window to rotate according to a rotation angle indicated by the rotation instruction; and
controlling the system window to rotate according to a rotation direction indicated by the rotation instruction.

4. The method as claimed in claim 1, wherein before translating the play window to the preset position in the system window, the method further comprises:
determining, according to a rotation angle, whether size information of the play window needs to be adjusted, wherein the play window rotates along with the rotation of the system window; and
if the size information of the play window needs to be adjusted, adjusting a size information of the play window, wherein the display image in the play window is redrawn after the size information of the play window is adjusted.

5. The method as claimed in claim 4, wherein if the size information of the play window has no need to be adjusted, redrawing the display image in the rotated play window.

6. The method as claimed in claim 4, wherein the rotation angle comprises one of 90°, 180° and 270°; determining, according to the rotation angle, whether the size information of the play window needs to be adjusted comprises:
if the rotation angle is 180°, determining not to adjust the size information of the play window; and
if the rotation angle is 90 or 270, determining to adjust the size information of the play window.

7. The method as claimed in claim 4, wherein the size information comprises a first length of the play window in a first direction of a play plane, and a second length of the play window in a second direction of the play plane, wherein the first direction is vertical to the second direction; adjusting the size information of the play window comprises:
determining the first length of the play window before adjustment as the second length of the play window after adjustment; and
determining the second length of the play window before adjustment as the first length of the play window after adjustment.

8. The method as claimed in claim 1, wherein transmitting the display image in the translated play window to the screen for display comprises:
transmitting the display image in the translated play window to a processing module, wherein the processing module intercepts the display image according to a layout parameter of the play window, and sends an intercepted image information to the screen for display.

9. The method as claimed in claim 4, wherein before transmitting a display image in the translated play window to the screen for display, the method further comprises:
redrawing the display image in the play window after adjusting the size information of the play window, which comprises:
obtaining a relative position of each child image layer on a parent image layer in an unrotated play window, wherein the parent image layer is the next image layer adjacent to the child image layer;
taking the play window whose size information has been adjusted as a root image layer at the bottom level, drawing each image layer in order from lowest to highest according to the relative position of each child image layer on the parent image layer until all image layers are drawn.

10. A method for controlling screen display, comprising:
displaying a play window in a first mode in a display area of a screen; and
in response to a rotation instruction, displaying the play window in a second mode in the display area of the screen, wherein the rotation instruction comprises a preset rotation angle, and the play window in the second mode is obtained by rotating the system window of the screen to the preset rotation angle and moving it to a preset position in the system window, the screen displays a display image in the play window after the translation;
wherein, while the system window rotates, the absolute position of the play window in the system window changes accordingly.

11. The method as claimed in claim 10, wherein when the rotation angle is 90° or 270°, length and width information of a first display image is opposite to that of a second display image; when the rotation angle is 180°, the first display image is opposite to the second display image in the vertical direction, wherein the first display image is the display image in the play window displayed in the first mode, and the second display image is the display image in the play window displayed in the second mode.

12. A system for controlling screen display, comprising:
a sending card, configured to receive a rotation instruction, rotate a system window of a screen according to the rotation instruction, translate a play window to a preset position in the system window, and transmit a display image in the translated play window to a receiving card, wherein when the system window is rotated, the absolute position of the play window in the system window changes accordingly;
a receiving card, configured to receive the display image sent by the sending card, and transmit the display image to the screen; and
the screen, configured to display the display image transmitted by the receiving card.

13. The system as claimed in claim 12, comprising:
a logic controller, connected between the sending card and the receiving card, and configured to intercept the play window according to a preset size, and send the intercepted display image to the receiving card.

14. (canceled)

15. (canceled)

16. (canceled)

17. The method as claimed in claims 2, wherein before translating the play window to the preset position in the system window, the method further comprises:
determining, according to the rotation angle, whether size information of the play window needs to be adjusted, wherein the play window rotates along with the rotation of the system window; and
if the size information of the play window needs to be adjusted, adjusting a size information of the play window, wherein the display image in the play window is redrawn after the size information of the play window is adjusted.

18. The method as claimed in claims 3, wherein before translating the play window to the preset position in the system window, the method further comprises:
determining, according to the rotation angle, whether size information of the play window needs to be adjusted, wherein the play window rotates along with the rotation of the system window; and
if the size information of the play window needs to be adjusted, adjusting a size information of the play window, wherein the display image in the play window is redrawn after the size information of the play window is adjusted.
